(19) United States
(12) Patent Application Publication
(10) Pub. No.: US 2013/0104718 A1
(43) Pub. Date: May 2, 2013

(54) CUTTER FOR SHEET-LIKE MEMBER

(71) Applicant: Yoshiaki Tai, Higashiyamato-shi (JP)

(72) Inventor: Yoshiaki Tai, Higashiyamato-shi (JP)

(73) Assignee: TRY-YEARN CO., LTD., Higashiyamato-shi, Tokyo (JP)

(21) Appl. No.: 13/806,717

(22) PCT Filed: Jun. 23, 2010
(86) PCT No.: PCT/JP2010/060675

§ 371 Date: Dec. 21, 2012

(51) Int. Cl. B26D 1/08

(52) U.S. Cl. CPC B26D 1/085
USPC 83/582

(57) ABSTRACT

A cutter for a sheet-like member is provided with a moving base (36) on which an edge (30a) of a moving blade (30) is positioned facing an edge (32a) of a fixed blade (32) with a tilt. The moving blade (30) is fixed to the moving base (36), which moves the moving blade (30) relative to the fixed blade (32). The moving blade (30) is pressed against the fixed blade (32) by an elastic force along a short-side direction and is moved by the moving base (36) toward the fixed blade (32), to thereby shear a sheet-like member W placed between the moving blade (30) and the fixed blade (32).

### TECHNICAL FIELD

The present invention relates to a cutter for a sheet-like member that cuts a sheet-like member by means of a reciprocating edge.

### BACKGROUND ART

A cutter for a sheet-like member is used to cut a flat member of a sheet-like or tape-like form having a moderate thickness. For example, Patent Document 1 relates to such a cutter.

As depicted in FIG. 5, a cutter 100 for a sheet-like member includes a moving blade 10 and a fixed blade 12. The moving blade 10 is tilted against an edge 12a of the fixed blade 12 and is mounted to a moving base 14 so that the cutting-start side of the edge 10a of the moving blade 10 is closer to the fixed blade 12 than is the cutting-end side of the same. The moving blade 10 is provided with a support shaft 10b projecting from both ends of the moving blade 10. The moving blade 10 is held against the moving base 14 such that the moving blade 10 is able to rotate around the support shaft 10b relative to the moving base 14. Springs 16 that continuously push the moving blade 10 toward the fixed blade 12 are disposed on the moving base 14 so that the cutting-start side of the edge 10a of the moving blade 10 is brought in pressure contact with a guide unit 12b projecting upward from an end of the fixed blade 12.

In this configuration, the moving base 14 is depressed toward the fixed blade 12 to press the edge 10a of the moving blade 10 against the edge 12a of the fixed blade 12 such that the cutting-start side and the cutting-end side are brought into contact with the edge 12a in sequence. Hence, a sheet-like member W placed between the moving blade 10 and the fixed blade 12 is cut.

### PRIOR ART DOCUMENT

### Patent Document

### Patent Document 1: Japanese Laid-Open Patent Publication No. 2007-105808

### SUMMARY OF THE INVENTION

### Problem to Be Solved by the Invention

A conventional cutter for a sheet-like member adopts a structure for continuously pushing the movable blade 10 toward the fixed blade 12. Such a structure is depicted in a partial enlarged side view of FIG. 6 in which the spring 16 is provided, and is depicted in a partial enlarged side view of FIG. 7 in which the moving blade 10 is anchored to the moving base 14 via a leaf spring 18.

To reduce the manufacturing cost of the cutter for the sheet-like member, it is desirable to avoid such complicated structures including the spring 16 or leaf spring 18 and achieve a simpler structure.

The present invention was conceived in view of the above problem, and it is therefore an object of the present invention to provide a cutter for a sheet-like member capable of cutting a sheet-like member with a simpler configuration than in the prior art.

### Means for Solving the Problem

One aspect of the present invention provides a cutter for a sheet-like member comprising a moving blade and a fixed blade arranged facing each other such that an edge of one blade is tilted against an edge of the other blade; and a moving base to which the moving blade is fixed, the moving base moving the moving blade relative to the fixed blade, wherein the moving blade is pressed against the fixed blade by an elastic force along a short-side direction and is moved by the moving base toward the fixed blade to shear a sheet-like member placed between the moving blade and the fixed blade.

The moving blade is preferably fixed to the moving base along a long-side direction.

The moving blade is preferably 0.1 mm to 1 mm in thickness.

### Effect of the Invention

The present invention enables a sheet-like member to be cut with a simpler configuration than in the prior art.

### BRIEF DESCRIPTION OF THE DRAWINGS

FIG. 1 is a front view of a form of a cutter for a sheet-like member according to an embodiment of the present invention;

FIG. 2 is an internal side view of a form of the cutter for the sheet-like member according to the embodiment;

FIG. 3 are side views of an action of the cutter for the sheet-like member according to the embodiment;

FIG. 4 is an internal side view of a form of the cutter for the sheet-like member according to the embodiment;

FIG. 5 consists of (a) a plan view, (b) a front view, and (c) an internal side view that depict a form of a conventional cutter for a sheet-like member;

FIG. 6 is an enlarged internal side view of a form of the conventional cutter for the sheet-like member; and

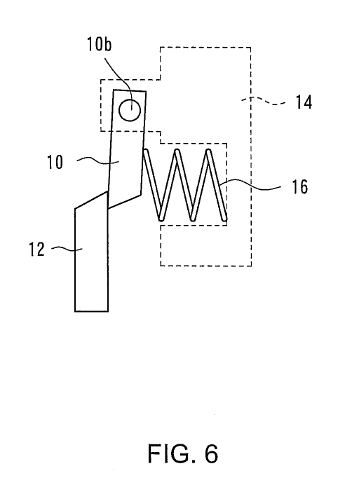

FIG. 7 is an enlarged internal side view of a form of the conventional cutter for the sheet-like member.

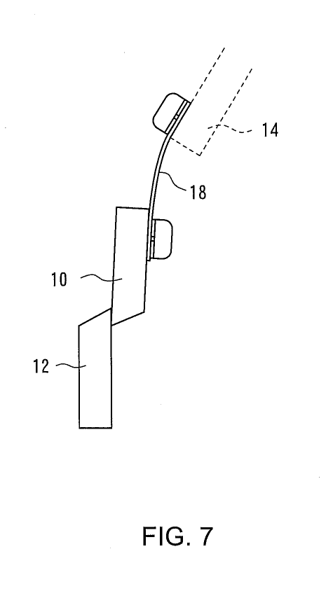

### BEST MODE FOR CARRYING OUT THE INVENTION

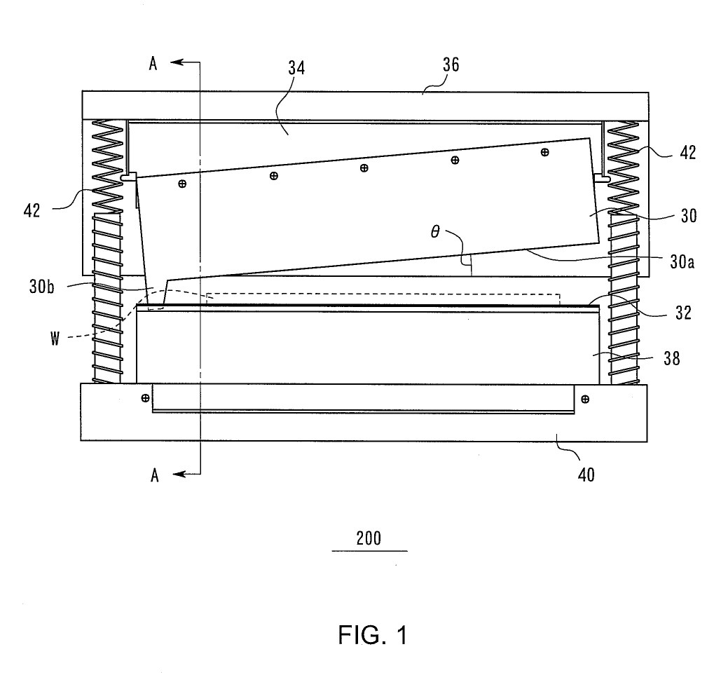

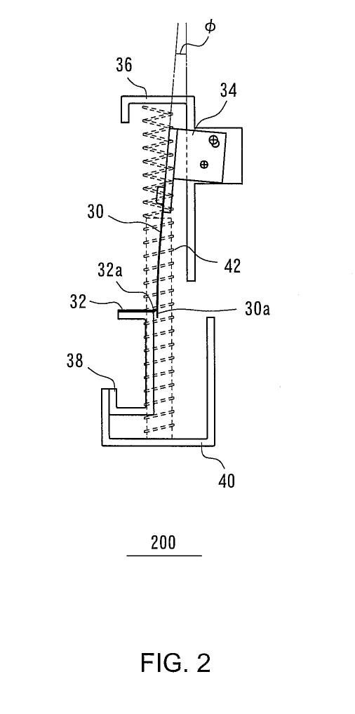

As depicted in a front view of FIG. 1 and an internal side view of FIG. 2, a cutter 200 for a sheet-like member according to an embodiment of the present invention includes a moving blade 30, fixed blade 32, a moving blade fixing unit 34, a moving base 36, a fixed blade fixing unit 38, a fixed base 40, and an elastic member 42.

The moving blade 30 is a substantially strip-shaped, plate-like elastic member having long sides and short sides. The moving blade 30 has a lower side (one of the long sides) serving as an edge 30a, and is fixed to the moving blade fixing unit 34 along an upper side (the other of the long sides). The moving blade 30 is fixed to the moving blade fixing unit 34 such that the edge 30a projects from the moving blade fixing unit 34 toward the fixed edge 32, as depicted in FIG. 2.

A material constituting the moving blade 30 has elasticity at least along a short-side direction. For example, the moving blade 30 may be provided as a plate-like member made by forming a metal into a strip shape. For example, the moving blade 30 may be made of a stainless strip or a very inexpensive hardened steel strip. To give the moving blade 30 elasticity in its short-side direction, it is preferable to determine the thickness of the moving blade 30 to be 0.1 mm to 1.0 mm. It is also preferable to make the long sides of the moving blade 30 slightly longer than a necessary cutting width. For example, when the long sides are relatively shorter, their length may be determined to be 10 mm, and when the long sides are relatively longer, their length may be determined to be 3,000 mm. The length of the short sides is determined to be a length within a range of lengths that give the moving blade 30 elasticity. For example, it is preferable that the short sides of 0.5 mm in thickness be about 35 mm in length and that the short sides of 1 mm in thickness be about 80 mm in length. The moving blade 30 having such dimensions allows efficient use of its elastic force in the short-side direction.

The moving blade fixing unit 34 supports the moving blade 30 so that its lower side (one of the long sides) does not warp in the long-side direction. The moving blade fixing unit 34 is fixed to the moving base 36. The moving base 36 is a member that moves the moving blade 30 toward the fixed blade 32, and is mounted to the fixed base 40 via the elastic member 42. The elastic member 42 is provided as, for example, a spring, etc. The moving base 36 also functions as a gripper unit that allows a user to press the moving blade 30 toward the fixed blade 32 without touching the moving blade 30. It is preferable that a guide means, etc., for regulating the direction of movement of the moving base 36 be provided to ensure smooth movement of the moving base 36 relative to the fixed base 40.

The fixed blade 32 is a substantially strip-shaped, plate-like member having long sides and short sides. The fixed blade 32 has an edge 32a against which the edge 30a of the moving blade 30 is pressed to shear a sheet-like member W placed between the fixed blade 32 and the moving blade 30. The fixed blade 32 uses one of its long sides (the long side located on the far side in relation to the surface of FIG. 1) as the edge 32a, and is laid down and fixed on the top of the fixed blade fixing unit 38 along the other of the long sides (the long side located this side to the surface of FIG. 1). The fixed blade 32 is fixed on the fixed blade fixing unit 38 such that the edge 32a projects from the fixed blade fixing unit 38 toward the moving blade 30 (far side in relation to the surface of FIG. 1), as depicted in FIG. 2.

A material constituting the fixed blade 32 is a material that allows the fixed blade 32 to be fitted to the fixed blade fixing unit 38 as the fixed blade 32 retains its rigidity. The fixed blade 32 is provided as a thin, elastic plate-like member. For example, the fixed blade 32 may be made of a hard stainless strip or inexpensive hardened steel strip. The fixed blade 32 may be provided not as a thin, elastic member but as a member with rigidity. For example, the fixed blade 32 may be made of hardened steel. The edge 32a of the fixed blade 32 has a downward relief angle so that the edge 30a of the moving blade 30 having hit the edge 32a to cut the member W does not hit the edge 32a again. It is preferable, for example, that the relief angle be about 10 degrees.

As depicted in FIG. 1, the moving blade 30 is tilted by an angle θ against the edge 32a of the fixed blade 32 in a horizontally fixed position and is fitted to the moving blade fixing unit 34 so that the cutting-start side of the edge 30a of the moving blade 30 (left side of FIG. 1) is closer to the fixed blade 32 than is the cutting-end side of the same (right side of FIG. 1).

As depicted in FIG. 2, the moving blade 30 is tilted by an angle Φ against the vertical direction and is mounted to the moving base 36 so that the edge 30a of the moving blade 30 is pressed against the edge 32a of the fixed blade 32. The moving blade 30 is provided as a plate-like member having elasticity along its short-side direction. As a result, the moving blade 30 is pressed against the edge 32a of the fixed blade 32 by an elastic force resulting from warpage of the moving blade 30 along in its short-side direction.

It is preferable that a guide 30b for providing guidance to the edge 32a of the fixed blade 32 be formed on the cutting-start side of the edge 30a of the moving blade 30 (left side of FIG. 1). The guide 30b is a plate-like projection projecting from the moving blade 30 toward the fixed blade 32, and remains in contact with the edge 32a of the fixed blade 32 even when the moving base 36 is separated from the fixed blade 32 across the maximum distance. The guide 30b may be formed on the fixed blade 32.

In this configuration, the moving base 36 is depressed toward the fixed blade 32, which causes the guide 30b to guide the edge 30a of the moving blade 30 to bring it into contact with the edge 32a of the fixed blade 32. The edge 30a of the moving blade 30 is thus pressed against the edge 32a of the fixed blade 32 such that the cutting-start side and the cutting-end side are brought into contact with the edge 32a in sequence. Hence the sheet-like member W placed between the moving blade 30 and the fixed blade 32 is sheared.

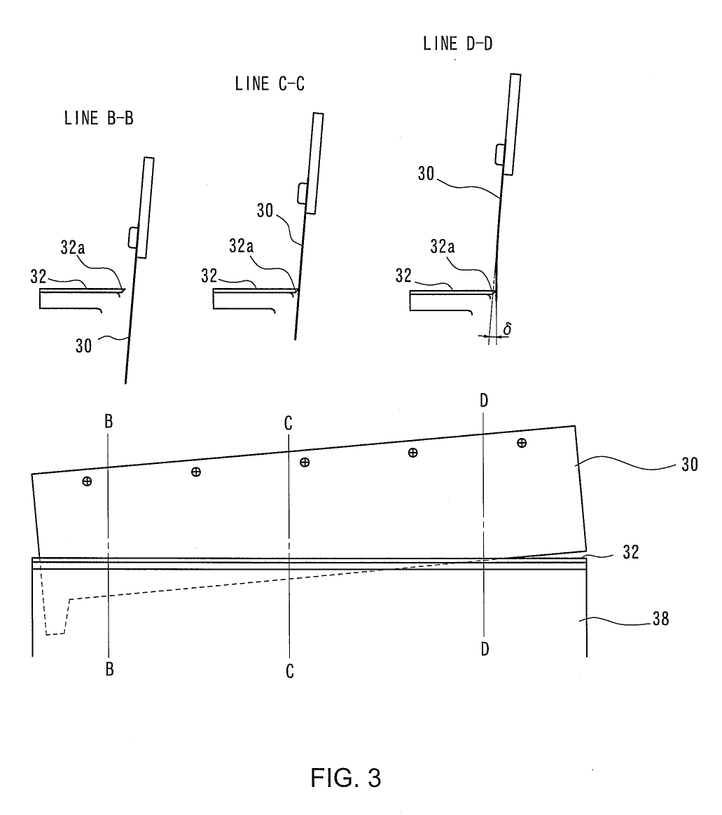

One of FIG. 3 on the lower side is a front view of the moving blade 30 and the fixed blade 32, and the other of FIG. 3 on the upper side depict states of contact between the moving blade 30 and the fixed blade 32 along lines B-B, C-C, and D-D. FIG. 3 depict a state where shearing starting from the cutting-start side of the edge 30a of the moving blade 30 has proceeded to the line D-D.

At the line D-D, the edge 30a of the moving blade 30 is pressed against the edge 32a of the fixed blade 32 to be in pressure contact with the edge 32a as the moving blade 30 warps by an angle δ in the short-side direction. At the line C-C, the moving blade 30 has little warpage. At the line B-B, the moving blade 30 is not in contact with the fixed blade 32. The moving blade 30 is brought into pressure contact with the fixed blade 32 between the line C-C and the line D-D, where the amount of a warpage of the moving blade 30 becomes the maximum at a shear spot on the line D-D. In this manner, a contact pressure between the edge 30a of the moving blade 30 and the edge 32a of the fixed blade 32 becomes the maximum at a spot at which the sheet-like member W is sheared. As a result, a strong shear force is obtained.

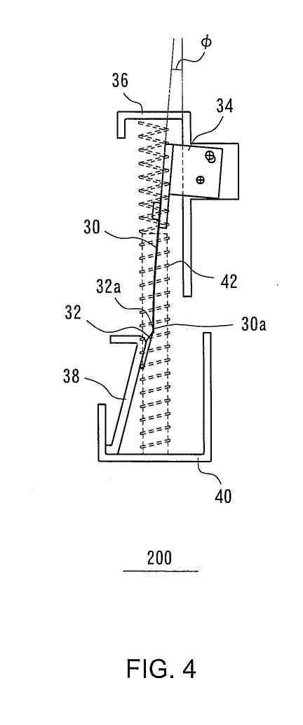

While the fixed blade 32 is laid down horizontally in the configuration of this embodiment, the fixed blade 32 may be erected vertically in another configuration, as depicted in a side view of FIG. 4. In the case of FIG. 4, as in the above case, the moving blade 30 is brought in contact with the fixed blade 32 using the elastic force in the short-side direction of the moving blade 30.

While the moving blade 30 is provided as an elastic member in this embodiment, the fixed blade 32 may be provided as an elastic member.

As described above, the cutter for the sheet-like member of the present invention differs a conventional cutter for a sheet-like member in that the moving blade is pressed against the fixed blade not by an elastic member, such as spring or leaf spring, but by the elastic force of the moving blade itself. This reduces the number of component members constituting the cutter, thus reducing the manufacturing cost of the cutter, and simplifies work of replacing the moving blade, thus facilitating maintenance, inspection, etc.

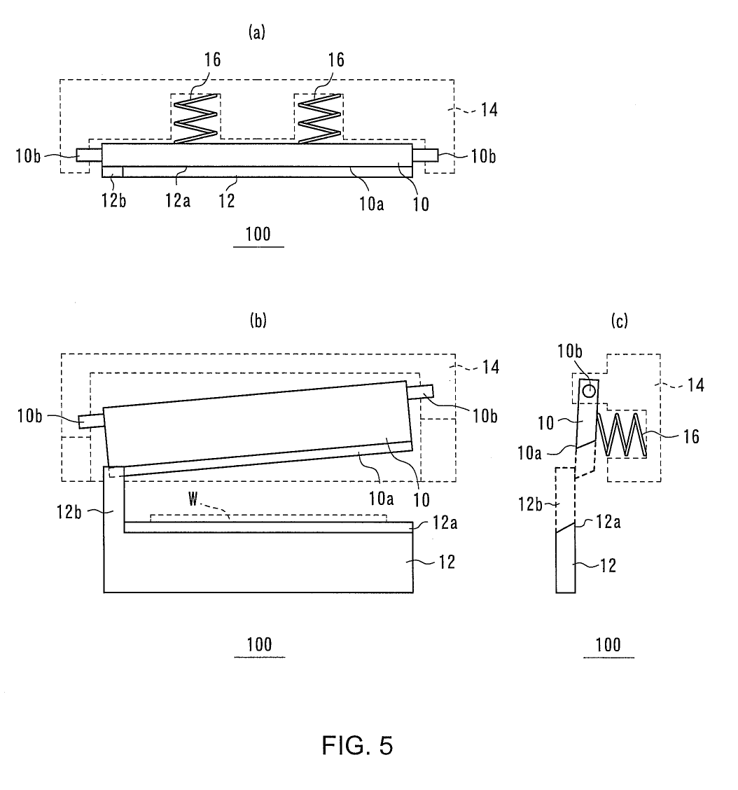

It is a major trend that a blade made of ground hardened steel is used as both a moving blade and a fixed blade. According to this embodiment, however, an inexpensive hardened steel strip can be used as the moving blade 30 and as the fixed blade 32 as well. As a result, the cost of the blade is reduced to 1/10 to 1/100 the original. Since the price of the blade accounts for a large percentage of the total price of the cutter for the sheet-like member, the cutter for the sheet-like member becomes very inexpensive compared to a conventional one, thanks to a combined effect of a simpler configuration and a cheaper blade. When a moving blade having rigidity is used, the moving blade may become incapable of cutting a thin workpiece in the middle of a cutting process, because of distortion, etc., of the moving blade. In such a case, it is necessary to devise a relief space perpendicular to the direction of cutting to allow the moving blade to escape to the relief space after cutting. In this embodiment, however, such a relief space is not necessary. For example, in a case of shears, etc., recessed parts of blades are set opposite each other so that they escape from each other after cutting is completed. Such a mechanism, however, is not necessary in this embodiment. In FIG. 5(a), both ends of the edge 10a of the moving blade 10 form a minute angle with the edge 12a of the fixed blade 12.

### EXPLANATION OF LETTERS AND REFERENCE NUMERALS

10 moving blade
10a edge
10b support shaft
12 fixed blade
12a edge
12b guide unit
14 moving base
16 spring
18 leaf spring
30 moving blade
30a edge
30b guide
32 fixed blade
32a edge
34 moving blade fixing unit
36 moving base
38 fixed blade fixing unit
40 fixed base
42 elastic member
100, 200 cutter for a sheet-like member

1. A cutter for a sheet-like member comprising:
a moving blade and a fixed blade arranged facing each other such that an edge of one blade is tilted against an edge of the other blade; and
a moving base to which the moving blade is fixed, the moving base moving the moving blade relative to the fixed blade, wherein
the moving blade is a hardened steel strip pressed against the fixed blade by an elastic force along a short-side direction and is moved by the moving base toward the fixed blade to shear a sheet-like member placed between the moving blade and the fixed blade.

2. The cutter for a sheet-like member of claim 1, wherein
the moving blade is fixed to the moving base along a long-side direction.

3. The cutter for a sheet-like member of claim 1, wherein
the moving blade is 0.1 mm to 1 mm in thickness.

4. The cutter for a sheet-like member of claim 2, wherein
the moving blade is 0.1 mm to 1 mm in thickness.
